(19) United States
(12) Patent Application Publication
(10) Pub. No.: US 2010/0138088 A1
(43) Pub. Date: Jun. 3, 2010

(54) INFORMATION SYSTEM USING VEHICLE, CHARGING DEVICE AND VEHICLE

(75) Inventors: Shinji Ichikawa, Ichinomiya-shi (JP); Tetsuhiro Ishikawa, Toyota-shi (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, TOYOTA-SHI (JP)

(21) Appl. No.: 12/451,413

(22) PCT Filed: May 14, 2008
(86) PCT No.: PCT/JP2008/059302

§ 371 Date: Nov. 12, 2009

(30) Foreign Application Priority Data
Jun. 6, 2007 (JP) 2007-150709

(51) Int. Cl. G06F 19/00

(52) U.S. Cl. 701/22

(57) ABSTRACT

A vehicle is configured to be rechargeable from a charging station through a charging cable. The charging cable is configured to allow supply of electric power from the charging station to the vehicle. A house is configured to allow transmission of physiological data of a vehicle user gathered at the house to the vehicle through the charging station and the charging cable. The vehicle is configured to allow receipt of physiological data of the vehicle user transmitted from the house through the charging cable to control on-vehicle equipment based on the received physiological data.

### TECHNICAL FIELD

The present invention relates to an information system using a vehicle, a charging device and a vehicle. More particularly, the present invention relates to an information system using a vehicle whose power storage device mounted thereon is rechargeable from a power source external to the vehicle, and relates to a charging device and a vehicle for use in the system.

### BACKGROUND ART

A system is publicly known which is capable of evaluating the condition of a driver according to physiological parameters of the driver measured during travel in a vehicle and driver's health-related data measured constantly at the driver's home area.

For example, Japanese National Patent Publication No. 2004-507308 discloses a method and a device for diagnosing the driver's fitness to drive. This method and device for diagnosing are based on the combination of driver's physiological measured values obtained during travel in the vehicle and the driver's health-related data measured constantly at the driver's home area. By means of an expert system, deviations of the driver's condition are weighted with parameters indicating the stress on the driver and are interpreted.

According to this method and device for diagnosing, a warning can be output to the driver based on the result of diagnosis made by the expert system. In case of emergency, auxiliary measures can be initiated.

In the system disclosed in the aforementioned Japanese National Patent Publication No. 2004-507308, driver's physiological data measured at the home area can also be utilized in addition to driver's physiological data measured during travel in the vehicle. However, there is a need to provide an additional transmission medium (such as a mobile radio system) for transmitting the physiological data measured at the home area to the vehicle.

Provision of such additional dedicated transmission medium results in increased costs. It is not necessary to transmit driver's physiological data measured at the home area from the home area to the vehicle continuously during travel of the vehicle. Since such data only needs to be transmitted once, for example, before starting travel of the vehicle, it is not required to provide a transmission medium that would allow continuous communication between the vehicle and home area.

### DISCLOSURE OF THE INVENTION

It is therefore an object of the present invention to provide an information system using a vehicle in which physiological data gathered outside the vehicle can be utilized in the vehicle at low cost.

It is another object of the present invention to provide a charging device and a vehicle to be employed in the information system in which physiological data gathered outside the vehicle can be utilized in the vehicle at low cost.

According to the present invention, an information system using a vehicle includes the vehicle, a power feeding device and a first communication device. The vehicle is configured to allow charging of a power storage device mounted thereon from a power source external to the vehicle. A power feeding device is configured to allow supply of electric power from the power source to the vehicle. The first communication device transmits physiological data of a vehicle user gathered outside the vehicle to the vehicle through the power feeding device. The vehicle includes a power receiving unit and a second communication device. The power receiving unit receives the electric power supplied from the power source through the power feeding device. The second communication device receives the physiological data input to the power receiving unit through the power feeding device.

Preferably, the vehicle further includes on-vehicle equipment and a control device. The on-vehicle equipment is configured to be operable in accordance with a given command. The control device controls the on-vehicle equipment based on the physiological data received by the second communication device.

Preferably, the power feeding device includes an electric power line for allowing electric connection of the vehicle with the power source external to the vehicle.

Preferably, the information system further includes a first detection device and a first storage device. The first detection device detects the physiological data outside the vehicle. The first storage device accumulates and stores the physiological data detected by the first detection device. The first communication device transmits the physiological data stored in the first storage device to the vehicle through the power feeding device.

Preferably, the second communication device is configured to allow further transmission of the physiological data received, to the outside of the vehicle through the power receiving unit.

Preferably, the vehicle further includes a second detection device and a second storage device. The second detection device detects physiological data of an occupant. The second storage device accumulates and stores the physiological data detected by the second detection device. The second communication device is configured to allow further transmission of the physiological data stored in the second storage device to the outside of the vehicle through the power receiving unit.

Preferably, the first communication device further transmits information registered by the vehicle user to the vehicle through the power feeding device. The second communication device is configured to allow further receipt of the information input to the power receiving unit through the power feeding device, and to allow further transmission of the received information to the outside of the vehicle through the power receiving unit.

According to the present invention, a charging device is capable of charging a power storage device mounted on a vehicle from a power source external to the vehicle, and includes a power feeding device and a communication device. The power feeding device is configured to allow supply of electric power from the power source to the vehicle. The communication device transmits physiological data of a vehicle user gathered outside the vehicle to the vehicle through the power feeding device.

Preferably, the power feeding device includes an electric power line for allowing electric connection of the vehicle to the power source external to the vehicle.

Preferably, the charging device further includes a detection device and a storage device. The detection device detects the physiological data outside the vehicle. The storage device accumulates and stores the physiological data detected by the detection device. The communication device transmits the physiological data stored in the storage device to the vehicle through the power feeding device.

According to the present invention, a vehicle includes a power storage device which is rechargeable, a power receiving unit, a voltage conversion device, a communication device, on-vehicle equipment and a control device. The power receiving unit receives electric power supplied from a power source external to the vehicle. The voltage conversion device is configured to allow voltage conversion of the electric power received through the power receiving unit for charging the power storage device. The communication device receives physiological data of a vehicle user gathered outside the vehicle and input to the power receiving unit during charging of the power storage device from the power source. The on-vehicle equipment is configured to be operable in accordance with a given command. The control device controls the on-vehicle equipment based on the physiological data received via the communication device.

Preferably, the communication device is configured to allow further transmission of the physiological data received, to the outside of the vehicle through the power receiving unit.

Preferably, the vehicle further includes a detection device and a storage device. The detection device detects physiological data of an occupant. The storage device accumulates and stores the physiological data detected by the detection device. The communication device is configured to allow further transmission of the physiological data stored in the storage device to the outside of the vehicle through the power receiving unit.

Preferably, the communication device is configured to allow further receipt of information registered by the vehicle user and input to the power receiving unit, and to allow further transmission of the received information to the outside of the vehicle through the power receiving unit.

According to the present invention, the vehicle is configured to allow charging of the power storage device from a power source external to the vehicle. Physiological data of a vehicle user gathered outside the vehicle is transmitted to the vehicle through the power feeding device while the power storage device is charged from the power source external to the vehicle.

Therefore, according to the present invention, physiological data gathered outside the vehicle can be utilized in the vehicle without having to provide an additional dedicated transmission medium. In addition, the use of a power feeding device for charging as a transmission medium allows a great amount of data gathered outside the vehicle to be transmitted to and utilized in the vehicle.

### BRIEF DESCRIPTION OF THE DRAWINGS

FIG. 1 is an overall view of an information system using a vehicle according to the present invention.

FIG. 2 is a functional block diagram of a house shown in FIG. 1.

FIG. 3 is a schematic configuration diagram of the vehicle shown in FIG. 1.

FIG. 4 is a flow chart for describing a control structure of a house ECU relating to data transmission from the house to the vehicle.

FIG. 5 is a flow chart for describing a control structure of a vehicle ECU in which physiological data transmitted from the house to the vehicle is utilized.

FIG. 6 is a flow chart for describing a control structure of the vehicle ECU relating to data transmission from the vehicle to the house.

FIG. 7 is a flow chart for describing a control structure of the house ECU in which physiological data transmitted from the vehicle to the house is utilized.

FIG. 8 is a functional block diagram of a motive power output device shown in FIG. 3.

FIG. 9 illustrates a zero-phase equivalent circuit of inverters and motor generators shown in FIG. 8.

FIG. 10 is a diagram for describing an information system in which information downloaded from the house to the vehicle can be utilized further at a destination.

FIG. 11 is a flow chart for describing a control structure of a house ECU relating to data transmission from a house to a vehicle, according to a second embodiment.

FIG. 12 is a flow chart for describing a control structure of a vehicle ECU relating to data transmission from the vehicle to a store, according to a second embodiment.

### BEST MODES FOR CARRYING OUT THE INVENTION

In the following, an embodiment of the present invention will be described in detail with reference to the drawings. Like reference characters denote like or corresponding parts throughout the drawings, and description thereof will not be repeated.

### First Embodiment

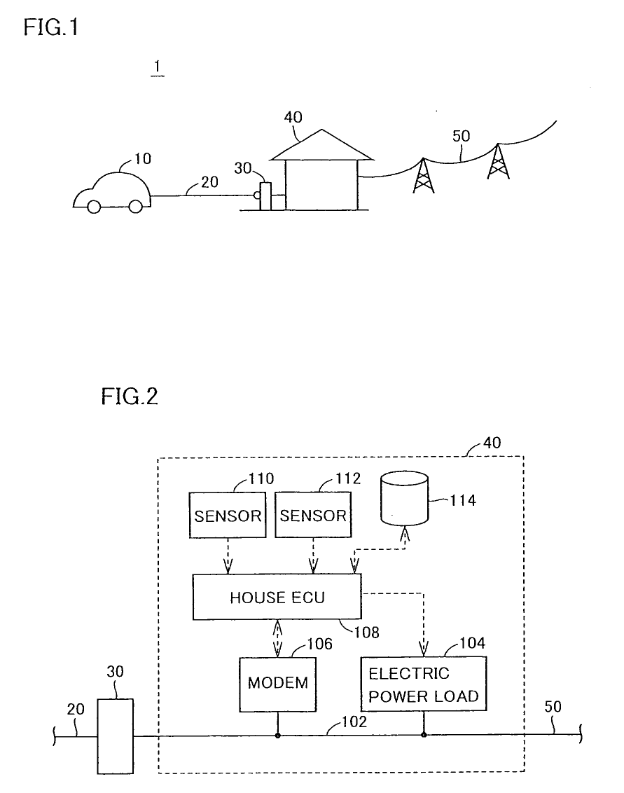

FIG. 1 is an overall view of an information system using a vehicle according to the present invention. Referring to FIG. 1, this information system 1 includes a vehicle 10, a charging cable 20, a charging station 30, a house 40 and a power transmission line 50.

Vehicle 10 is an electrically-powered vehicle having mounted thereon a rechargeable power storage device and a motor that generates a vehicle driving force using electric power received from the power storage device. Although vehicle 10 will be described below as a hybrid vehicle with an engine further mounted thereon, vehicle 10 may be an electric vehicle powered only by a motor, or a fuel cell vehicle with a fuel cell further mounted thereon.

Vehicle 10 is electrically connectable to charging station 30 through charging cable 20. Vehicle 10 is configured to allow receipt of a supply of system power sequentially through power transmission line 50, house 40, charging station 30 and charging cable 20 by a method which will be described later to charge the on-vehicle power storage device.

In addition, vehicle 10 receives physiological data of a vehicle user (e.g., blood pressure, heart rate, body weight, body fat percentage and temperature) gathered at house 40, from house 40 through charging station 30 and charging cable 20. Vehicle 10 is configured to allow execution of various kinds of control of on-vehicle equipment (e.g., temperature control and air volume/airflow direction setting of an air conditioner, control of a seat heater, seat adjustment and music selection) based on the received physiological data.

Further, vehicle 10 detects physiological data of the vehicle user aboard the vehicle by means of various types of sensors to accumulate and store the detected data. Vehicle 10 is configured to allow transmission of the accumulated physiological data to house 40 through charging cable 20 and charging station 30.

Although the vehicle user will be described herein as a particular user, there may be several vehicle users. By identifying such several vehicle users by user IDs in vehicle 10 and house 40, the vehicle users can be treated individually in a similar manner to the case of a particular user.

Charging cable 20 is an electric power line for connecting vehicle 10 to charging station 30. Charging cable 20 also serves as a communication medium between vehicle 10 and house 40. Charging station 30 is connected to house 40, and configured to provide connection for charging cable 20. Charging station 30 receives, from house 40, the system power supplied through power transmission line 50 to supply charging power to vehicle 10 connected through charging cable 20.

House 40 is configured to allow supply of a portion of the system power received through power transmission line 50 to charging station 30. House 40 detects physiological data of the vehicle user by means of various types of sensors provided in the house to accumulate and store the detected data. House 40 is configured to allow transmission of the accumulated physiological data to vehicle 10 through charging station 30 and charging cable 20.

In addition, house 40 is configured to allow receipt of physiological data of the vehicle user aboard the vehicle gathered at vehicle 10, from vehicle 10 through charging cable 20 and charging station 30. House 40 is configured to allow execution of various kinds of control (e.g., temperature control of an air conditioner, temperature control of bath water and display of food menu according to physical conditions) based on the received physiological data.

In this information system 1, physiological data of the vehicle user is gathered both at vehicle 10 and house 40. The physiological data is transmitted and received between vehicle 10 and house 40 through charging cable 20 and charging station 30 when vehicle 10 is connected to charging station 30 through charging cable 20. This allows the physiological data of the vehicle user gathered at vehicle 10 and house 40 to be shared between and utilized in vehicle 10 and house 40.

FIG. 2 is a functional block diagram of house 40 shown in FIG. 1. Referring to FIG. 2, house 40 includes an electric power bus 102, an electric power load 104, a modem 106, a house ECU (Electronic Control Unit) 108, sensors 110, 112, and a storage device 114.

Electric power bus 102 is connected to power transmission line 50 and charging station 30. Electric power load 104 is connected to electric power bus 102. This electric power load 104 generically represents various electric loads in house 40. Electric power load 104 is configured to be operable in accordance with a command from house ECU 108.

Modem 106 is connected to electric power bus 102. This modem 106 is a communication interface device for conducting communication between house 40 and vehicle 10 through electric power bus 102, charging station 30 and charging cable 20. Modem 106 transmits the physiological data of the vehicle user accumulated in storage device 114 to vehicle 10 (FIG. 1) through electric power bus 102, charging station 30 and charging, cable 20, in accordance with a command from house ECU 108. Modem 106 receives the physiological data of the vehicle user gathered at vehicle 10, from vehicle 10 through charging cable 20, charging station 30 and electric power bus 102.

Sensors 110 and 112 detect physiological data of the vehicle user in house 40. While two sensors are illustrated herein by way of example, the number of sensors is not limited to two, and more than two sensors may be provided. These sensors 110 and 112 are contact-type or noncontact-type sensors installed at an appropriate location in house 40, for detecting, for example, blood pressure, heart rate, body weight, body fat percentage, body temperature and the like of the vehicle user. Sensors 110 and 112 output the detected data to house ECU 108.

Storage device 114 receives, from house ECU 108, the physiological data of the vehicle user detected by sensors 110 and 112 to accumulate and store the received data. Storage device 114 also outputs the stored data to house ECU 108 according to a command from house ECU 108.

House ECU 108 gathers the physiological data of the vehicle user detected by sensors 110 and 112 to output the gathered physiological data to storage device 114. Then, house ECU 108 reads, from storage device 114, the physiological data of the vehicle user accumulated in storage device 114 while vehicle 10 is connected to charging station 30 through charging cable 20, to output the read data to vehicle 10 via modem 106.

Upon receipt of the physiological data of the vehicle user gathered at vehicle 10 and transmitted from vehicle 10 via modem 106, house ECU 108 executes control of electric power load 104 (e.g., temperature control of an air conditioner, temperature control of bath water and the like, as mentioned above) based on the received physiological data.

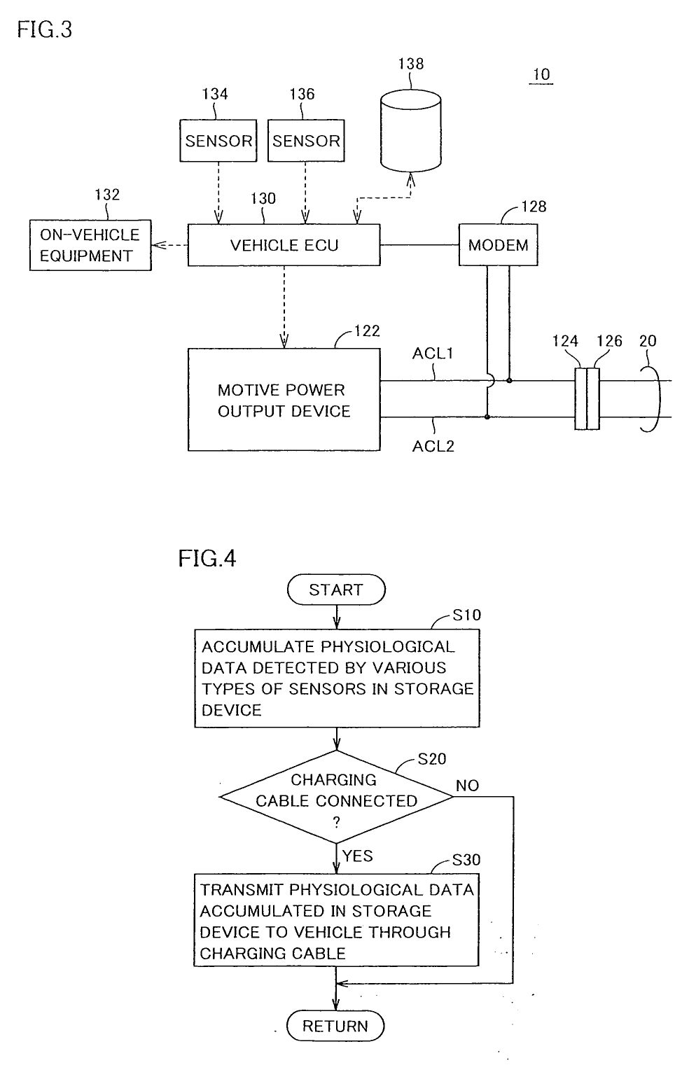

FIG. 3 is a schematic configuration diagram of vehicle 10 shown in FIG. 1. Referring to FIG. 3, vehicle 10 includes a motive power output device 122, electric power lines ACL1 and ACL2, a connector 124, a modem 128, a vehicle ECU 130, on-vehicle equipment 132, sensors 134, 136, and a storage device 138.

Motive power output device 122 outputs the traveling driving force for this vehicle 10. According to a charge command from vehicle ECU 130, motive power output device 122 converts charging power (system power) received from charging station 30 (FIG. 1) through electric power lines ACL1 and ACL2 into DC power to charge its internal power storage device (not shown). The configuration of motive power output device 122 will be described later.

Electric power lines ACL1 and ACL2 are provided between motive power output device 122 and connector 124. Connector 124 is connected to electric power lines ACL1 and ACL2, and configured to be connectable to connector 126 at the side of charging cable 20. By being connected to connector 126 at the side of charging cable 20, connector 124 electrically connects electric power lines ACL1 and ACL2 to charging cable 20.

Modem 128 is connected to electric power lines ACL1 and ACL2. This modem 128 is a communication interface device for conducting communication between vehicle ECU 130 and house ECU 108 (FIG. 2) at house 40 through electric power lines ACL1, ACL2, charging cable 20 and charging station 30. Modem 128 receives physiological data of the vehicle user gathered at house 40 from house 40 through charging station 30, charging cable 20, electric power lines ACL1 and ACL2. Modem 128 also transmits physiological data of the vehicle user accumulated in storage device 138 to house 40 through electric power lines ACL1, ACL2, charging cable 20 and charging station 30, in accordance with a command from vehicle ECU 130.

On-vehicle equipment 132 generically represents various electric devices in vehicle 10, and includes, for example, an air conditioner, a power seat, a seat heater, audio equipment and the like. On-vehicle equipment 132 is configured to be operable in accordance with a command from vehicle ECU 130.

Sensors 134 and 136 detect physiological data of the vehicle user in vehicle 10. While two sensors are illustrated herein by way of example, the number of sensors is not limited to two, and more than two sensors may be provided. These sensors include, for example, a contact-type sensor installed in the steering wheel, the shift lever, a seat, a door knob or the like to detect, for example, blood pressure, heart rate, body weight and body fat percentage of the occupant. Alternatively, these sensors may include a noncontact-type sensor which detects occupant's body temperature by infrared radiation or detects the blinking state of the driver through images. Each sensor outputs its detected data to vehicle ECU 130.

Storage device 138 receives, from vehicle ECU 130, the physiological data of the vehicle user detected by sensors 134 and 136 to accumulate and store the received data. Storage device 138 outputs the stored data to vehicle ECU 130 according to a command from vehicle ECU 130.

When vehicle 10 takes a running-enable state, vehicle ECU 130 generates a torque command value for motor generators included in motive power output device 122 to output the generated torque command value to motive power output device 122.

Vehicle ECU 130 outputs an operation command to motive power output device 122 such that motive power output device 122 carries out voltage conversion of the charging power (system power) received from charging station 30 through electric power lines ACL1 and ACL2 for charging the power storage device.

Upon receipt of the physiological data of the vehicle user gathered at and transmitted from house 40 via modem 128, vehicle ECU 130 executes various kinds of control of on-vehicle equipment 132 (e.g., temperature control and air volume/airflow direction setting of an air conditioner, control of seat heater, seat adjustment and music selection as mentioned above) based on the received physiological data.

Vehicle ECU 130 gathers the physiological data detected by sensors 134 and 136 while the vehicle user is aboard the vehicle to output the gathered physiological data to storage device 138. Vehicle ECU 130 reads, from storage device 138, the physiological data of the vehicle user accumulated in storage device 138 while vehicle 10 is connected to charging station 30 through charging cable 20 to output the read data to house 40 via modem 128. Whether or not the vehicle user is aboard the vehicle can be determined by, for example, a seat sensor.

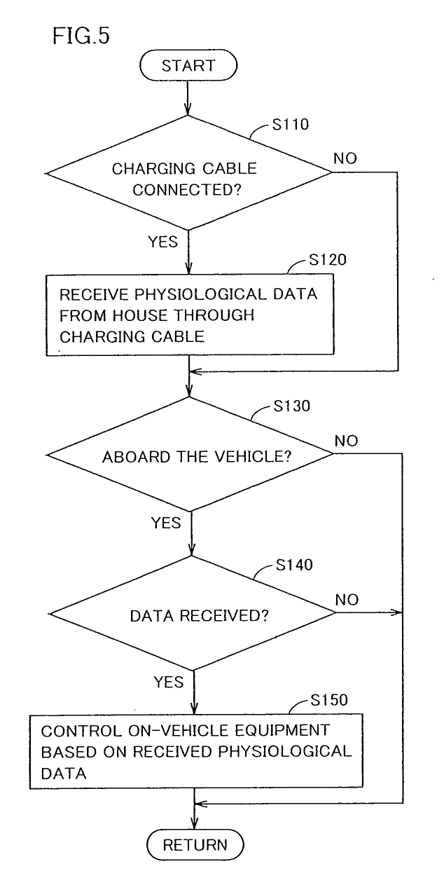

FIG. 4 is a flow chart for describing a control structure of house ECU 108 relating to data transmission from house 40 to vehicle 10. The process in this flow chart is invoked from a main routine and executed at regular time intervals or each time predetermined conditions are met.

Referring to FIGS. 4 and 2, house ECU 108 gathers physiological data of the vehicle user detected by sensors 110 and 112 to output the gathered physiological data to storage device 114 (step S10).

Next, house ECU 108 determines whether or not charging cable 20 is connected to charging station 30 (step S20). House ECU 108 can determine whether or not charging cable 20 is connected to charging station 30 by, for example, making an attempt to communicate with vehicle 10 (FIG. 1). During charging of the power storage device from charging station 30, it is naturally determined that charging cable 20 is connected to charging station 30.

When it is determined that charging cable 20 is connected to charging station 30 (YES in step S20), house ECU 108 reads, from storage device 114, the physiological data accumulated in storage device 114 to transmit the read physiological data to vehicle 10 via modem 106 through charging station 30 and charging cable 20 (step S30).

FIG. 5 is a flow chart for describing a control structure of vehicle ECU 130 in which data transmitted from house 40 to vehicle 10 is utilized. The process in this flow chart is also invoked from the main routine and executed at regular time intervals or each time predetermined conditions are met.

Referring to FIGS. 5 and 3, vehicle ECU 130 determines whether or not charging cable 20 is connected to charging station 30 (FIG. 1) (step S110). Vehicle ECU 130 can determine whether or not charging cable 20 is connected to charging station 30 by, for example, making an attempt to communicate with house 40 (FIG. 1). During charging of the power storage device from charging station 30, it is naturally determined that charging cable 20 is connected to charging station 30.

When it is determined that charging cable 20 is connected to charging station 30 (YES in step S110), vehicle ECU 130 receives the physiological data of the vehicle user transmitted from house 40 through charging cable 20 via modem 128 (step S120). When it is determined that charging cable 20 is not connected to charging station 30 (NO in step S110), vehicle ECU 130 proceeds into step S130 without executing step S120.

Next, vehicle ECU 130 determines whether or not the vehicle user is aboard the vehicle (step S130). Vehicle ECU 130 can determine whether or not the vehicle user is aboard the vehicle by, for example, a seat sensor.

When it is determined that the user is aboard the vehicle (YES in step S130), vehicle ECU 130 determines whether or not there is data received from house 40 (step S140). When it is determined that there is received data (YES in step S140), vehicle ECU 130 executes the above-mentioned control of on-vehicle equipment 132 based on the received physiological data of the vehicle user (step S150).

When it is determined in step S130 that the vehicle user is not aboard the vehicle (NO in step S130) or it is determined in step S140 that there is no received data (NO in step S140), vehicle ECU 130 returns the process to the main routine.

In step S150, on-vehicle equipment 132 may be controlled utilizing the physiological data of the vehicle user detected by sensors 134 and 136 in vehicle 10 and accumulated in storage device 138, in addition to the data received from house 40 via modem 128.

In this manner, the physiological data of the vehicle user gathered at house 40 can be transmitted to vehicle 10 from house 40 through charging cable 20 for utilization in controlling on-vehicle equipment 132 in vehicle 10. As described above, the physiological data of the vehicle user gathered at vehicle 10 can also be transmitted from vehicle 10 to house 40 through charging cable 20 for utilization in controlling electric power load 104 in house 40.

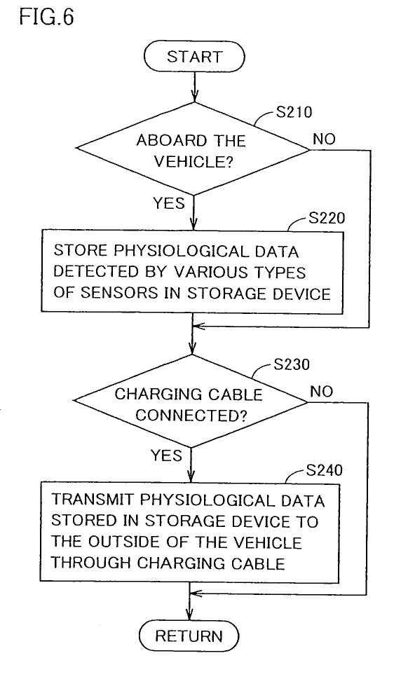

FIG. 6 is a flow chart for describing a control structure of vehicle ECU 130 relating to data transmission from vehicle 10 to house 40. The process in this flow chart is also invoked from the main routine and executed at regular time intervals or each time predetermined conditions are met.

Referring to FIGS. 6 and 3, vehicle ECU 130 determines whether or not the vehicle user is aboard the vehicle (step S210). While the vehicle is traveling, it is naturally determined that the user is aboard the vehicle. When it is determined that the user is aboard the vehicle (YES in step S210), vehicle ECU 130 gathers the physiological data of the vehicle user detected by sensors 134 and 136 to output the gathered physiological data to storage device 138 (step S220). When it is determined that the vehicle user is not aboard the vehicle (NO in step S210), vehicle ECU 130 proceeds into step S230 without executing step S220.

Next, vehicle ECU 130 determines whether or not charging cable 20 is connected to charging station 30 (FIG. 1) (step S230). During charging of the power storage device from charging station 30, it is naturally determined that charging cable 20 is connected to charging station 30. When it is determined that charging cable 20 is connected to charging station 30 (YES in step S230), vehicle ECU 130 reads, from storage device 138, the physiological data accumulated in storage device 138 to output the read physiological data to house 40 (FIG. 1) through charging cable 20 and charging station 30 via modem 128 (step S240).

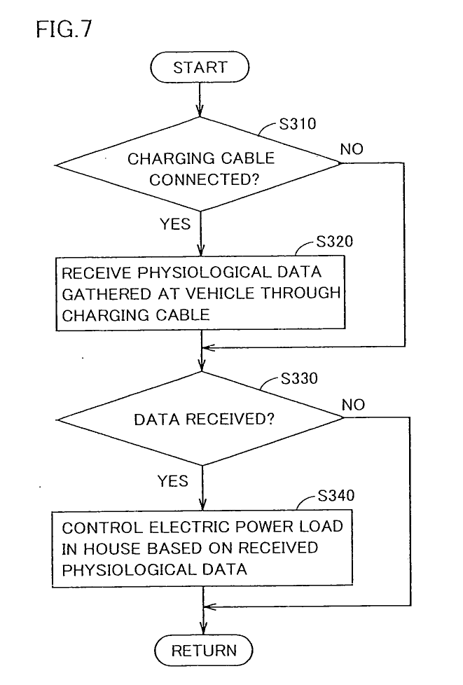

FIG. 7 is a flow chart for describing a control structure of house ECU 108 in which physiological data transmitted from vehicle 10 to house 40 is utilized. The process in this flow chart is also invoked from the main routine and executed at regular time intervals or each time predetermined conditions are met.

Referring to FIGS. 7 and 2, house ECU 108 determines whether or not charging cable 20 is connected to charging station 30 (step S310). When it is determined that charging cable 20 is connected to charging station 30 (YES in step S310), house ECU 108 receives the physiological data of the vehicle user transmitted from vehicle 10 (FIG. 1) through charging cable 20 via modem 106 (step S320). When it is determined that charging cable 20 is not connected to charging station 30 (NO in step S310), house ECU 108 proceeds into step S330 without executing step S320.

Next, house ECU 108 determines whether or not there is data received from vehicle 10 (step S330). When it is determined that there is received data (YES in step S330), house ECU 108 executes the above-mentioned control of electric power load 104 based on the received physiological data of the vehicle user.

In step S340, electric power load 104 may be controlled utilizing the physiological data of the vehicle user detected by sensors 110 and 112 in house 40 and accumulated in storage device 114, in addition to the data received from vehicle 10 via modem 106.

The configuration of motive power output device 122 (FIG. 3) of vehicle 10 will now be described.

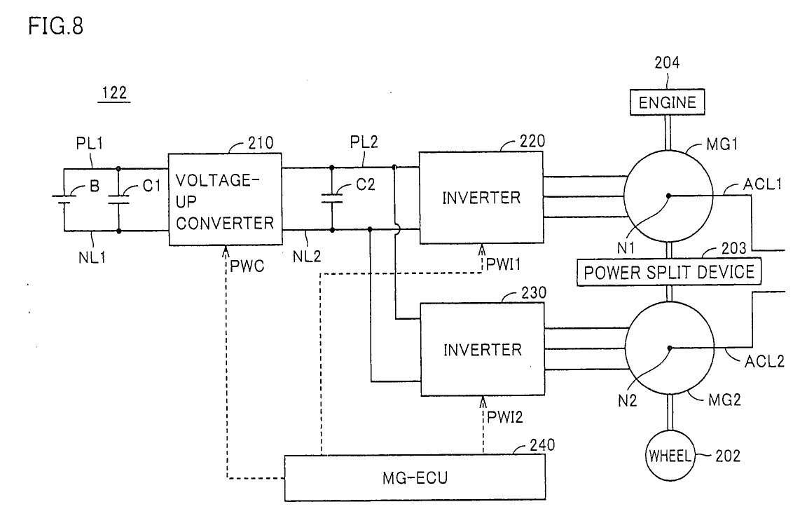

FIG. 8 is a functional block diagram of motive power output device 122 shown in FIG. 3. Referring to FIG. 8, motive power output device 122 includes an engine 204, motor generators MG1 and MG2, a power split device 203 and a wheel 202. Motive power output device 122 further includes a power storage device B, a voltage-up converter 210, inverters 220 and 230, an MG-ECU 240, capacitors C1 and C2, positive electrode lines PL1 and PL2, and negative electrode lines NL1 and NL2.

Power split device 203 is coupled to engine 204, and motor generators MG1 and MG2 to distribute motive power among them. For instance, as power split device 203, a planetary gear having three rotation shafts of a sun gear, a planetary carrier and a ring gear can be used. These three rotation shafts are connected to the rotation shafts of engine 204, motor generator MG1, and motor generator MG2, respectively.

Motor generator MG1 is incorporated in motive power output device 122 to operate as a generator driven by engine 204 and as a motor that can start engine 204. Motor generator MG2 is incorporated in motive power output device 122 as a motor for driving wheel 202 which is a driven wheel.

Each of motor generators MG1 and MG2 includes a Y-connected three-phase coil not shown, as a stator coil. Electric power line ACL1 is connected to a neutral point N1 of the three-phase coil of motor generator MG1. Electric power line ACL2 is connected to a neutral point N2 of the three-phase coil of motor generator MG2.

Power storage device B is a rechargeable DC power source, and composed of, for example, a nickel-metal hydride or lithium ion secondary battery. Power storage device B outputs DC power to voltage-up converter 210. Power storage device B is charged by receiving electric power output from voltage-up converter 210. A high-capacity capacitor may be used as power storage device B.

Capacitor C1 smoothes voltage variations between positive-electrode line PL1 and negative-electrode line NL1. Voltage-up converter 210 boosts a DC voltage received from power storage device B according to a signal PWC from MG-ECU 240 to output the boosted voltage to positive-electrode line PL2. Voltage-up converter 210 down-converts DC voltages received from inverters 220 and 230 through positive-electrode line PL2 to the voltage level of power storage device B according to signal PWC for charging power storage device B. Voltage-up converter 210 is comprised of, for example, a chopper circuit of the voltage-up/down type, or the like.

Capacitor C2 smoothes voltage variations between positive-electrode line PL2 and negative-electrode line NL2. Inverter 220 converts a DC voltage received through positive-electrode line PL2 into a three-phase AC voltage according to a signal PWI1 from MG-ECU 240 to output the converted three-phase AC voltage to motor generator MG1. Inverter 220 converts a three-phase AC voltage generated by motor generator MG1 receiving power of engine 204 into a DC voltage according to signal PWI1 to output the converted DC voltage to positive-electrode line PL2.

Inverter 230 converts a DC voltage received through positive-electrode line PL2 into a three-phase AC voltage according to a signal PWI2 from MG-ECU 240 to output the converted three-phase AC voltage to motor generator MG2. Accordingly, motor generator MG2 is driven so as to produce an indicated torque. During regenerative braking of the vehicle, inverter 230 converts a three-phase AC voltage generated by motor generator MG2 receiving the rotational force from wheel 202 into a DC voltage according to signal PWI2 to output the converted DC voltage to positive-electrode line PL2.

When power storage device B is charged from charging station 30 (FIG. 1), inverters 220 and 230 convert the charging power (system power) supplied to neutral points N1 and N2 through electric power lines ACL1 and ACL2 into DC power according to signals PWI1 and PWI2 to output the converted DC power to positive-electrode line PL2.

Each of motor generators MG1 and MG2 is a three-phase AC motor, and comprised of, for example, a three-phase AC synchronous motor. Motor generator MG1 produces a three-phase AC voltage by means of the power of engine 204 to output the produced three-phase AC voltage to inverter 220. Motor generator MG1 produces the driving force by the three-phase AC voltage received from inverter 220 to start engine 204. Motor generator MG2 produces the driving torque for the vehicle by the three-phase AC voltage received from inverter 230. Motor generator MG2 produces a three-phase AC voltage during regenerative braking of the vehicle for output to inverter 230.

According to torque command values TR1 and TR2 from vehicle ECU 130 (FIG. 3), MG-ECU 240 generates a signal PWC for driving voltage-up converter 210, and signals PWI1 and PWI2 for driving inverters 220 and 230, respectively, to output the generated signals PWC, PWI1 and PWI2 to voltage-up converter 210, inverter 220 and inverter 230, respectively.

During charging of power storage device B from charging station 30, MG-ECU 240 generates signals PWI1, PWI2 and PWC for controlling inverter 220, inverter 230 and voltage-up converter 210, respectively, such that the charging power (system power) supplied to neutral points N1 and N2 through electric power lines ACL1 and ACL2 is converted into DC power for charging power storage device B.

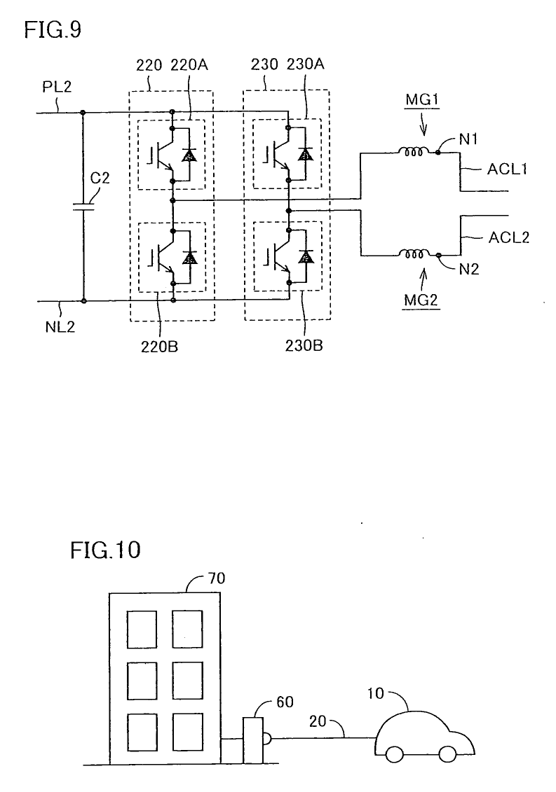

FIG. 9 illustrates a zero-phase equivalent circuit of inverters 220 and 230, and motor generators MG1 and MG2 shown in FIG. 8. In each of inverters 220 and 230 as three-phase inverters, there are eight patterns of on/off combination of six transistors. In two of the eight switching patterns, the phase-to-phase voltages become zero, and such a voltage state is referred to as a zero-voltage vector. For the zero-voltage vector, three upper-arm transistors can be regarded as being in the same switching state to each other (all on or off), and three lower-arm transistors can also be regarded as being in the same switching state to each other. Therefore, in FIG. 9, three upper-arm transistors of inverter 220 are generically shown as an upper arm 220A, and three lower-arm transistors of inverter 220 are generically shown as a lower arm 220B. Similarly, three upper-arm transistors of inverter 230 are generically shown as an upper arm 230A, and three lower-arm transistors of inverter 230 are generically shown as a lower arm 230B.

As shown in FIG. 9, this zero-phase equivalent circuit can be regarded as a single-phase PWM converter receiving the charging power (single-phase AC power) supplied to neutral points N1 and N2 through electric power lines ACL1 and ACL2. Then, the zero-voltage vector is changed in each of inverters 220 and 230 to control switching such that inverters 220 and 230 operate as legs of the single-phase PWM converter. Accordingly, the charging power (single-phase AC power) received through electric power lines ACL1 and ACL2 can be converted into DC power for output to positive-electrode line PL2.

As described above, in this first embodiment, vehicle 10 is configured to allow charging of power storage device B from charging station 30 through charging cable 20. While vehicle 10 is connected to charging station 30 through charging cable 20, the physiological data of the vehicle user gathered at house 40 is transmitted to vehicle 10 through charging cable 20. Therefore, according to the first embodiment, the physiological data gathered at house 40 can be utilized in vehicle 10 without having to provide an additional dedicated transmission medium. The use of charging cable 20 as a transmission medium allows a great amount of physiological data gathered at house 40 to be transmitted to and utilized in vehicle 10.

According to the first embodiment, the physiological data of the vehicle user gathered at vehicle 10 can also be transmitted to house 40 through charging cable 20 while vehicle 10 is connected to charging station 30 through charging cable 20. Therefore, according to the first embodiment, the physiological data gathered at vehicle 10 can also be utilized at house 40.

In other words, this first embodiment allows the physiological data of the vehicle user gathered both at vehicle 10 and house 40 to be shared between and utilized in vehicle 10 and house 40.

### Second Embodiment

In the second embodiment, information in house 40 registered by a vehicle user is downloaded further to vehicle 10 from house 40 through charging cable 20 while vehicle 10 is connected to charging station 30 through charging cable 20. Then, when away from home, the information downloaded to vehicle 10 from house 40 and physiological data of the vehicle user is transmitted to a site away from home, from vehicle 10 through charging cable 20, while vehicle 10 is connected to a charging station provided at the site through charging cable 20 for utilization in various kinds of control at the site.

FIG. 10 is a diagram for describing an information system in which information downloaded from house 40 to vehicle 10 can be utilized further at a destination. Referring to FIG. 10, this information system includes a store 70 shown as an example of the destination and a charging station 60.

Charging station 60 is connected to store 70, and configured to allow connection of charging cable 20. Charging station 60 receives, from store 70, electric power for charging vehicle 10 to supply charging power to vehicle 10 connected through charging cable 20.

Store 70 is configured to allow supply of charging station 60 with electric power for charging vehicle 10 connected to charging station 60. Store 70 is also configured to allow receipt of information downloaded from house 40 (FIG. 1) to vehicle 10, from vehicle 10 through charging cable 20 and charging station 60. Store 70 is a supermarket, a convenience store or the like. The above-mentioned information is information in house 40 registered by the vehicle user (e.g., information about stock of food in a refrigerator, articles for everyday use and medicine). Based on the information received from vehicle 10, store 70 informs the vehicle user of articles to be purchased, their prices and the like, or produces customer information of the vehicle user.

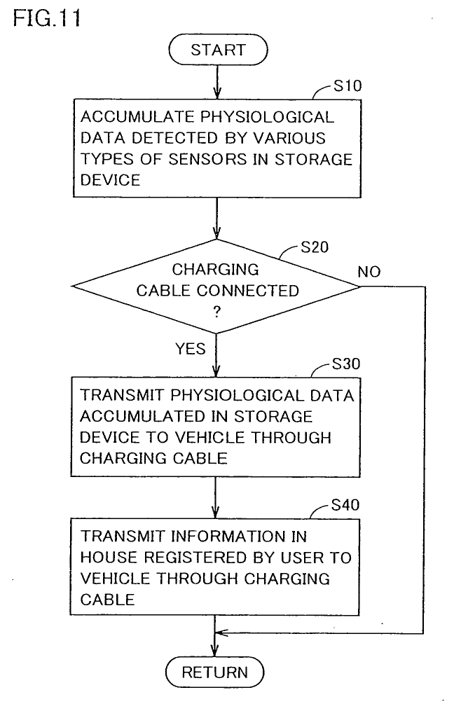

FIG. 11 is a flow chart for describing a control structure of house ECU 108 relating to data transmission from house 40 to vehicle 10, according to the second embodiment. The process in this flow chart is also invoked from the main routine and executed at regular time intervals or each time predetermined conditions are met.

Referring to FIGS. 11 and 2, this flow chart further includes step S40 in the flow chart shown in FIG. 4. More specifically, when the physiological data accumulated in storage device 114 is transmitted to vehicle 10 in step S30, house ECU 108 transmits the information in house 40 registered by the user to vehicle 10 through charging station 30 and charging cable 20 via modem 106 (step S40).

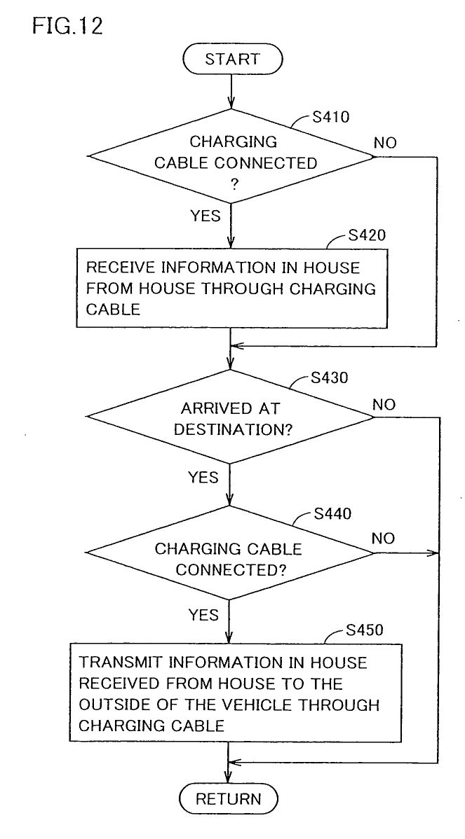

FIG. 12 is a flow chart for describing a control structure of vehicle ECU 130 relating to data transmission from vehicle 10 to store 70, according to the second embodiment. The process in this flow chart is also invoked from the main routine and executed at regular time intervals or each time predetermined conditions are met.

Referring to FIGS. 12, 3 and 10, vehicle ECU 130 determines whether or not charging cable 20 is connected to charging station 30 (FIG. 1) (step S410). When it is determined that charging cable 20 is connected to charging station 30 (YES in step S410), vehicle ECU 130 receives, via modem 128, the information in house 40 transmitted from house 40 (FIG. 1) through charging cable 20 (step S420). When it is determined that charging cable 20 is not connected to charging station 30 (NO in step S410), vehicle ECU 130 proceeds into step S430 without executing step S420.

Next, vehicle ECU 130 determines whether or not vehicle 10 has arrived at a destination (store 70) (step S430). Vehicle ECU 130 can determine whether or not vehicle 10 has arrived at the destination (store 70) by means of, for example, a car navigation device not shown.

When it is determined that vehicle 10 has arrived at the destination (store 70) (YES in step S430), vehicle ECU 130 determines whether or not charging cable 20 is connected to charging station 60 (step S440). When it is determined that charging cable 20 is connected to charging station 60 (YES in step S440), vehicle ECU 130 transmits the information in house 40 downloaded from house 40 to a place external to the vehicle (store 70) via modem 128 through charging cable 20 and charging station 60 (step S450).

When it is determined in step S430 that vehicle 10 has not arrived at the destination (store 70) (NO in step 5430) or it is determined in step S440 that charging cable 20 is not connected to charging station 60 (NO in step S440), vehicle ECU 130 returns the process to the main routine.

Although not specifically illustrated, when the destination is an office, the physiological data of the vehicle user transmitted from house 40 to vehicle 10, and further, the physiological data gathered at vehicle 10 during travel from house 40 to the office can also be transmitted from vehicle 10 to the office through charging cable 20 for utilization in the office.

In addition, although not specifically illustrated, various types of information and physiological data of the vehicle user may be transmitted from the destination to vehicle 10 through charging cable 20 while vehicle 10 is connected to a charging station at the destination through charging cable 20.

As described above, according to the second embodiment, the information downloaded from house 40 to vehicle 10 (information in house 40 and physiological data of the vehicle user) can be transmitted further to the destination through charging cable 20 while vehicle 10 is connected to a charging station at the destination through charging cable 20. Therefore, according to the second embodiment, exchange of various kinds of information among the house, the vehicle and the destination through charging cable 20 allows the information to be shared among and utilized in the house, the vehicle and the destination.

Although charging cable 20 is connected to charging station 30 in the above-described embodiments, the configuration may be such that charging cable 20 connected to charging station 30 is connected to vehicle 10. Charging station 30 and house 40 or charging station 60 and store 70 may be configured integrally.

It has been described in the above embodiments that power storage device B is charged by providing the system power supplied from charging station 30 to neutral points N1 and N2 through electric power lines ACL1 and ACL2 to cause inverters 220 and 230, and motor generators MG1 and MG2 to operate as a single-phase PWM converter. However, an additional dedicated converter for charging power storage device B from charging station 30 may be provided.

While it has been described in the above embodiments that a so-called series/parallel-type hybrid vehicle in which the power of engine 204 is distributed to motor generator MG1 and wheel 202 by means of power split device 203, the present invention is also applicable to a so-called series-type hybrid vehicle in which the power of engine 204 is applied only to power generation by motor generator MG1 and the traveling driving force for the vehicle is produced only by means of motor generator MG2. Further, the application range of the invention is not limited to a hybrid vehicle. The invention may also be applied to an electric vehicle with no engine mounted thereon, or a fuel cell vehicle with a rechargeable power storage device mounted thereon.

In the foregoing, charging cable 20 corresponds to one embodiment of “the power feeding device” according to the present invention. Modem 106 corresponds to one embodiment of “the first communication device” according to the present invention. Connector 124, electric power lines ACL1 and ACL2 constitute one embodiment of “the power receiving unit” according to the present invention. Modem 128 corresponds to one embodiment of “the second communication device” according to the present invention. Vehicle ECU 130 corresponds to one embodiment of “the control device” according to the present invention.

Sensors 110 and 112 correspond to one embodiment of “the first detection device” according to the present invention. Storage device 114 corresponds to one embodiment of “the first storage device” according to the present invention. Sensors 134 and 136 correspond to one embodiment of “the second detection device” according to the present invention. Storage device 138 corresponds to one embodiment of “the second storage device” according to the present invention. Motor generators MG1 and MG2, inverters 220 and 230, and voltage-up converter 210 constitute one embodiment of “the voltage conversion device” according to the present invention.

It should be understood that the embodiments disclosed herein are illustrative and non-restrictive in every respect. The scope of the present invention is defined by the claims, and is intended to include any modification within the meaning and scope equivalent to the terms of the claims.

1. An information system using a vehicle, comprising:
the vehicle configured to allow charging of a power storage device mounted thereon from a power source external to the vehicle;
a power feeding device configured to allow supply of electric power from said power source to said vehicle; and
a first communication device for transmitting physiological data of a vehicle user gathered outside the vehicle to said vehicle through said power feeding device, wherein
said vehicle includes:
a power receiving unit for receiving the electric power input to said power source through said power feeding device;
a second communication device for receiving said physiological data input to said power receiving unit through said power feeding device;
on-vehicle equipment configured to be operable in accordance with a given command; and
a control device for controlling said on-vehicle equipment based on said physiological data received by said second communication device.

2. (canceled)

3. The information system according to claim 1, wherein said power feeding device includes an electric power line for allowing electric connection of said vehicle with said power source external to the vehicle.

4. The information system according to claim 1, further comprising:
a first detection device for detecting said physiological data outside said vehicle; and
a first storage device for accumulating and storing the physiological data detected by said first detection device, wherein
said first communication device transmits the physiological data stored in said first storage device to said vehicle through said power feeding device.

5. The information system according to claim 1, wherein said second communication device is configured to allow further transmission of said physiological data received, to the outside of the vehicle through said power receiving unit.

6. The information system according to claim 1, wherein
said vehicle further includes:
a second detection device for detecting physiological data of an occupant; and
a second storage device for accumulating and storing the physiological data detected by said second detection device, and
said second communication device is configured to allow further transmission of the physiological data stored in said second storage device to the outside of the vehicle through said power receiving unit.

7. The information system according to claim 1, wherein
said first communication device further transmits information registered by said vehicle user to said vehicle through said power feeding device, and
said second communication device is configured to allow further receipt of said information input to said power receiving unit through said power feeding device, and to allow further transmission of the received information to the outside of the vehicle through said power receiving unit.

8. (canceled)

9. (canceled)

10. (canceled)

11. A vehicle comprising:
a power storage device which is rechargeable;
a power receiving unit for receiving electric power supplied from a power source external to the vehicle;
a voltage conversion device configured to allow voltage conversion of the electric power received through said power receiving unit for charging said power storage device;
a communication device for receiving physiological data of a vehicle user gathered outside the vehicle and input to said power receiving unit during charging of said power storage device from said power source;
on-vehicle equipment configured to be operable in accordance with a given command; and
a control device for controlling said on-vehicle equipment based on said physiological data received via said communication device.

12. The vehicle according to claim 11, wherein said communication device is configured to allow further transmission of said physiological data received, to the outside of the vehicle through said power receiving unit.

13. The vehicle according to claim 11, further comprising:
a detection device for detecting physiological data of an occupant; and
a storage device for accumulating and storing the physiological data detected by said detection device, wherein
said communication device is configured to allow further transmission of the physiological data stored in said storage device to the outside of the vehicle through said power receiving unit.

14. The vehicle according to claim 11, wherein said communication device is configured to allow further receipt of information registered by said vehicle user and input to said power receiving unit, and to allow further transmission of the received information to the outside of the vehicle through said power receiving unit.

15. The vehicle according to claim 12, wherein said communication device is configured to allow further receipt of information registered by said vehicle user and input to said power receiving unit, and to allow further transmission of the received information to the outside of the vehicle through said power receiving unit.

16. The vehicle according to claim 13, wherein said communication device is configured to allow further receipt of information registered by said vehicle user and input to said power receiving unit, and to allow further transmission of the received information to the outside of the vehicle through said power receiving unit.
